(19) United States
(12) Patent Application Publication
(10) Pub. No.: US 2019/0320079 A1
(43) Pub. Date: Oct. 17, 2019

(54) DOCUMENT READING APPARATUS, DOCUMENT READING METHOD, AND STORAGE MEDIUM STORING CONTROL PROGRAM

(71) Applicant: SHARP KABUSHIKI KAISHA, Osaka (JP)

(72) Inventors: HIDEAKI KURIMOTO, Osaka (JP); TOHRU NISHIKAWA, Sakai City (JP)

(21) Appl. No.: 16/382,842

(22) Filed: Apr. 12, 2019

(30) Foreign Application Priority Data
Apr. 17, 2018 (JP) 2018-079355

(51) Int. Cl. H04N 1/12; H04N 1/00

(52) U.S. Cl. CPC H04N 1/121; H04N 1/00013; H04N 1/1205; H04N 1/00604

(57) ABSTRACT

There is provided a document reading apparatus which automatically transports a document placed on a document tray to read an image. In a case of reading the document placed on the document tray, a document tray moving unit moves the document tray and a pickup roller presses the document based on a first instruction by a first operation button so that a state in which the document is placed is shifted to a document feeding available state, and a reading process of the document is started based on a second instruction by a second operation button.

### BACKGROUND

### 1. Field

The present disclosure relates to a document reading apparatus, a document reading method, and a control program, specifically, a document reading apparatus which automatically transports a document to read an image.

### 2. Description of the Related Art

In the related art, in general, an image forming apparatus such as a copy machine or the like generates an output image based on image data of a document read by a document reading apparatus or image data input from a separated terminal and outputs the output image.

In the document reading apparatus, a plurality of documents can be placed on a document tray, and an ADF mechanism automatically transports the documents one by one from the document tray to read the documents.

In a case of reading the document by using the ADF mechanism, in general, by touching a soft key (an operation button) of the UI or a hard key (an operation button) provided on the document reading apparatus, a state is shifted to a document feeding state.

For example, as a technology in the related art, there is disclosed an image reading apparatus (see Japanese Unexamined Patent Application Publication No. 8-101460). When reading a document is started, the image reading apparatus instructs a document tray moving portion to move a document tray to a first position at which the document can be fed in a case where a document detection portion detects that the document is placed on the document tray, and instructs the document tray moving portion to move the document tray to a second position at which the document is not fed in a standby status.

However, in the related art described above, since the document placed on the document tray is moved to the position at which the document is fed and hold even in a case where it is desired to reconfirm the document or misplacement of the document, there is a problem in that it becomes difficult to reset the document placed beforehand or to take the document out for reconfirmation.

It is desirable to provide a document reading apparatus, a document reading method, and a control program capable of easily handing a document on a document tray.

### SUMMARY

According to an aspect of the disclosure, there is provided a document reading apparatus which automatically transports a document placed on a document tray to read an image, in which in a case of reading the document placed on the document tray, shifting a state in which the document is placed to a document feeding available state is performed based on a first instruction, and a reading process of the document is started based on a second instruction.

According to another aspect of the disclosure, there is provided a document reading method for automatically transporting a document placed on a document tray to read an image, the method including: in a case of reading the document placed on the document tray, shifting a state in which the document is placed to a document feeding available state based on a first instruction; and starting a reading process of the document based on a second instruction.

According to still another aspect of the disclosure, there is provided a storage medium storing control program for operating a document reading apparatus which automatically transports a document placed on a document tray to read an image, the program causing a computer to function to: in a case of reading the document placed on toe document tray, shift a state in which the document is placed to a document feeding available state based on a first instruction; and start a reading process of the document based on a second instruction.

### BRIEF DESCRIPTION OF THE DRAWINGS

FIG. 1 is an explanatory diagram illustrating an overall configuration of an image forming apparatus mounting a document reading apparatus according to a first embodiment;

FIG. 2 is an explanatory diagram cross-sectionally illustrating a configuration of an automatic document processing apparatus constituting the document reading apparatus;

FIG. 3 is a block diagram illustrating an electrical configuration of the document reading apparatus;

FIG. 4 is a flowchart illustrating an example of a step of a document reading process in the document reading apparatus;

FIG. 5 is a part of a flowchart illustrating an example of a step of a document reading process in a document reading apparatus according to a second embodiment;

FIG. 6 is a flowchart of a document reading process following the flowchart in FIG. 5;

FIG. 7 is a part of a flowchart illustrating an example of a step of a document reading process in a document reading apparatus according to a third embodiment;

FIG. 8 is a part of a flowchart illustrating an example of a step of a document reading process in a document reading apparatus according to a fourth embodiment;

FIG. 9 is a part of a flowchart illustrating an example of a step of a document reading process in a document reading apparatus according to a fifth embodiment;

FIG. 10 is a part of a flowchart illustrating an example of a step of a document reading process in a document reading apparatus according to a sixth embodiment;

FIG. 11 is a block diagram illustrating an electrical configuration of a document reading apparatus according to a seventh embodiment;

FIG. 12 is a flowchart illustrating an example of a step of a document reading process in the document reading apparatus;

FIG. 13 is a block diagram illustrating an electrical configuration of a document reading apparatus according to an eighth embodiment;

FIG. 14 is a flowchart illustrating an example of a step of a document reading process in the document reading apparatus; and

FIG. 15 is a flowchart illustrating an example of a step of a document reading process in a document reading apparatus according to a ninth embodiment.

### DESCRIPTION OF THE EMBODIMENTS

### First Embodiment

Hereinafter, a first embodiment of the present disclosure will be described with reference to the accompanying drawings.

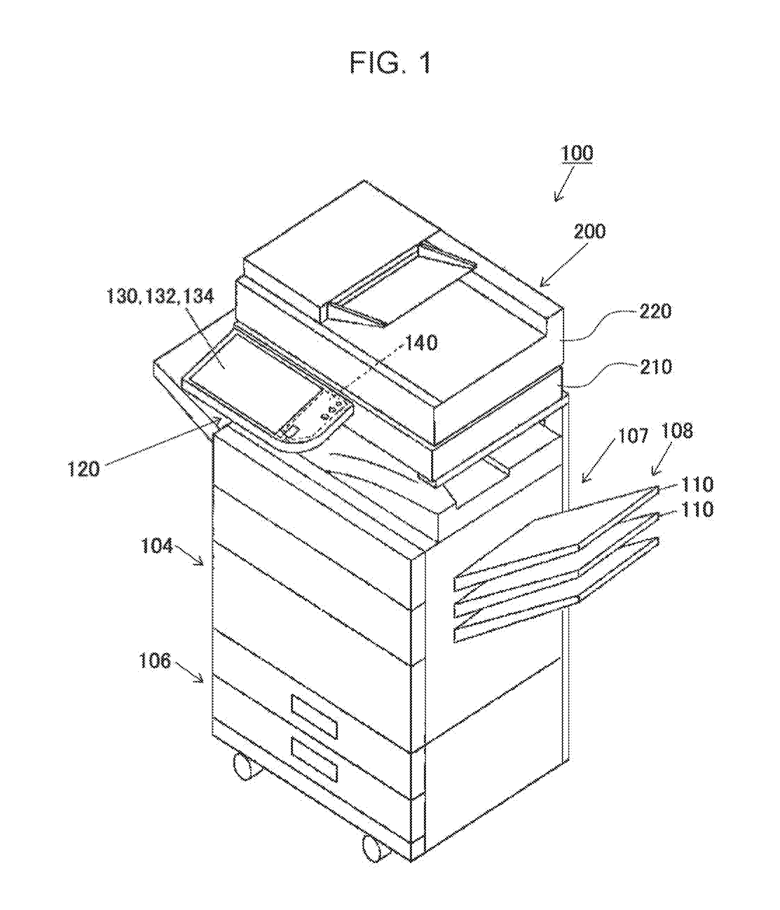

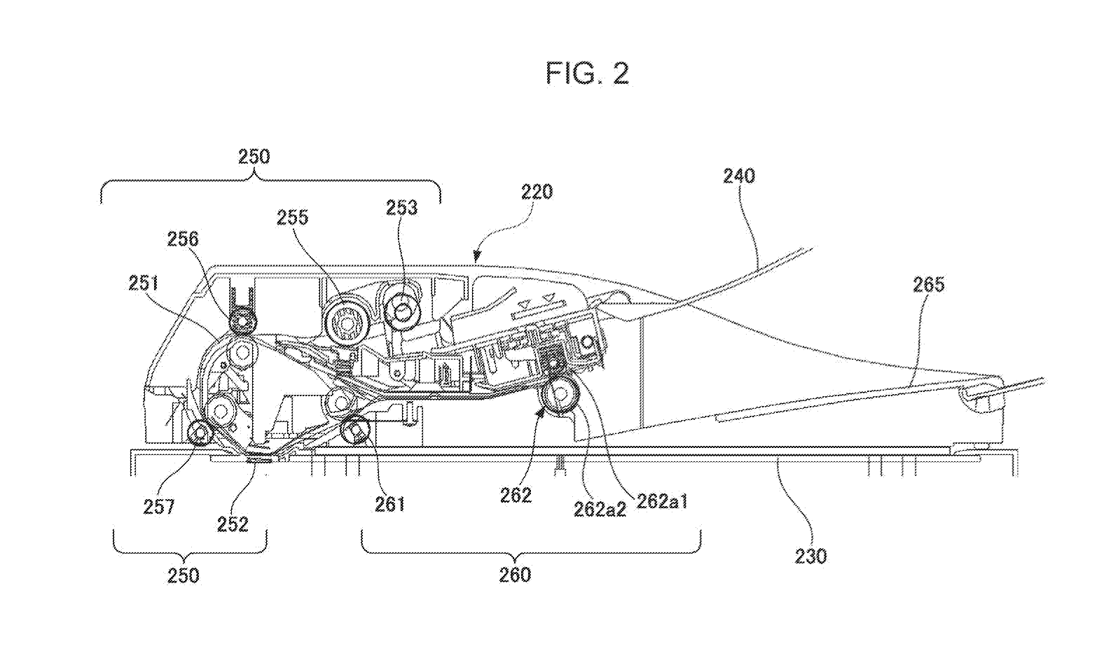

FIG. 1 is an example of an embodiment of the disclosure and is an explanatory diagram illustrating an overall configuration of an image forming apparatus mounting a document reading apparatus according to the first embodiment, and FIG. 2 is an explanatory diagram cross-sectionally illustrating a configuration of an automatic document processing apparatus constituting the document reading apparatus.

As illustrated in FIG. 1, the first embodiment is an image forming apparatus 100 mounting a document reading apparatus 200 which automatically transports a document to be read (hereinafter, simply referred to as “document”) and reads an image, and capable of outputting the image based on the read document. The document reading apparatus 200 has a characteristic configuration of a document reading apparatus according to the present disclosure.

The image forming apparatus 100 forms an image on a recording sheet by an electrophotographic method.

The image forming apparatus 100 includes, as operation modes, a copy mode, a facsimile mode (a FAX mode), a document filing mode (a mode of storing a scanned image in a storage device inside an image forming apparatus), and a mail mode (a scanned image is transmitted by being attached to an e-mail).

The image forming apparatus 100 may further include a network printer mode.

The document reading apparatus 200 mostly includes a scanner unit 210 which reads an image of a document and an automatic document processing apparatus 220 which automatically transports the document.

The scanner unit 210 is provided on an upper part of a body of the image forming apparatus 100.

The automatic document processing apparatus 220 is provided in an operable and closeable manner so as to face an upper part of the scanner unit 210, and also functions as a document pressing unit which presses the document placed on the scanner unit 210. Accordingly, it possible to perform a document reading process for each of sheets.

In addition, by mounting the automatic document processing apparatus 220 on the upper part of the scanner unit 210, an automatic continuous reading process of a plurality of documents can be performed and both sides of the document can be read at the same time.

### Configuration of Image Forming Apparatus

First, a basic configuration of the image forming apparatus 100 according to the first embodiment will be described.

As illustrated in FIG. 1, the image forming apparatus 100 according to the first embodiment mostly includes an image forming unit 104 which forms an image based on image data read by the scanner unit 210, a paper feeding unit 106 which feeds a sheet, an image output portion 107 which outputs the image formed based on the image data, a paper discharge processing device 108, a control unit (not illustrated) which controls an overall apparatus, and an operation unit 120.

The paper discharge processing device 108 performs a process of classifying a plurality of recording sheets into each of paper discharge trays 110 and discharging the recording sheet, a process of punching each of the recording sheets, and a process of stapling each of the recording sheets.

For example, in a case of generating a plurality of copies of printed matters, each of the recording sheets is classified and discharged into each of the paper discharge trays 110 so that some of the printed matters are assigned to each of the paper discharge trays 110 at a time, and for each of the paper discharge trays 110, a punching process by a punching unit (not illustrated) or a stapling process by a stapling unit (not illustrated) is executed on each of the recording sheet on the paper discharge tray 110 and the printed matter is generated.

As illustrated in FIG. 1, the operation unit 120 mostly includes a touch panel display (a display unit) 130 and a display operation unit 140. The touch panel display 130 mostly includes a display panel 132 including a liquid crystal panel or the like and a touch panel 134 which is disposed to overlap the display panel 132 and which detects a position at which a finger of a user is pressed.

The image forming apparatus 100 includes the touch panel display 130 as a central operation device, and the display operation unit 140 including a hardware key and a pilot lamp.

The image forming apparatus 100 is not limited to including the display operation unit 140 having such a configuration, and may include only the touch panel display 130.

In addition, the operation unit 120 for operating the image forming apparatus 100 also functions as an operation unit of the document reading apparatus 200.

### Overall Configuration of Document Reading Apparatus

Next, the automatic document processing apparatus 220 constituting the document reading apparatus 200 of the image forming apparatus 100 according to the first embodiment will be described in detail with reference to drawings.

As illustrated in FIG. 2, the automatic document processing apparatus 220 mostly includes a document tray 240, a paper feeding unit 250, and a paper discharge unit 260.

A document is placed on the document tray 240.

The paper feeding unit 250 mostly includes a document transport path 251, a document reading window 252, a pickup roller 253, a paper feeding roller 255, an upper transport roller 256, and a reading transport roller 257.

The paper discharge unit 260 mostly includes a lower transport roller 261, a paper discharge roller 262, and a paper discharge tray 265.

Specifically, the pickup roller 253 feeds the documents placed on the document tray 240 one by one into the paper feeding roller 255. The paper feeding roller 255 supplies the document into the apparatus. The upper transport roller 256 transports the document supplied into the apparatus to the document transport path 251. The reading transport roller 257 transports the document to the document reading window 252 at a prescribed timing. The lower transport roller 261 transports the document read by the document reading window 252 for a discharge. The paper discharge roller 262 discharges the document transported to the lower transport roller 261 onto the paper discharge tray 265.

The automatic document processing apparatus 220 configured as described above takes out the document set in the document tray 240 one by one from an uppermost position of the document stack by the paper feeding roller 255, transports the document into the apparatus, and guides and passes the document onto an SPF glass (a contact glass) provided in the document reading window 252 of the scanner unit 210 via the document transport path 251, and then discharges the document onto the paper discharge tray 265.

When the document passes over the document reading window 252, the scanner unit 210 iterates reading of an image of a surface of the document in a central scanning direction by a CCD (not illustrated) and outputs image data indicating the image of the surface of the document.

On the other hand, in a case where the document is placed on a platen glass (a document table glass) 230 on an upper surface of the scanner unit 210, a scanning unit or an optical system (not illustrated) are moved while maintaining a prescribed speed relationship with each other, the surface of the document on the platen glass 230 is exposed, and a reflected light from the surface of the document is guided to an image formation lens (not illustrated) by the scanning unit or the optical system so as to form an image on the surface of the document on the CCD.

The paper discharge roller 262 and the paper discharge tray 265 are formed on a lower side of the document tray 240. The paper discharge roller 262 mostly includes a pair of roller members of an upper paper discharge roller 262a1 and a lower paper discharge roller 262a2.

The upper paper discharge roller 262a1 is rotatably supported. The lower paper discharge roller 262a2 is rotatable forward and backward by a motor (not illustrated). The upper paper discharge roller 262a1 is driven to rotate by rotation of the lower paper discharge roller 262a2.

### Characteristic Configuration of Document Reading Apparatus

Next, a characteristic configuration of the document reading apparatus 200 according to the first embodiment will be described.

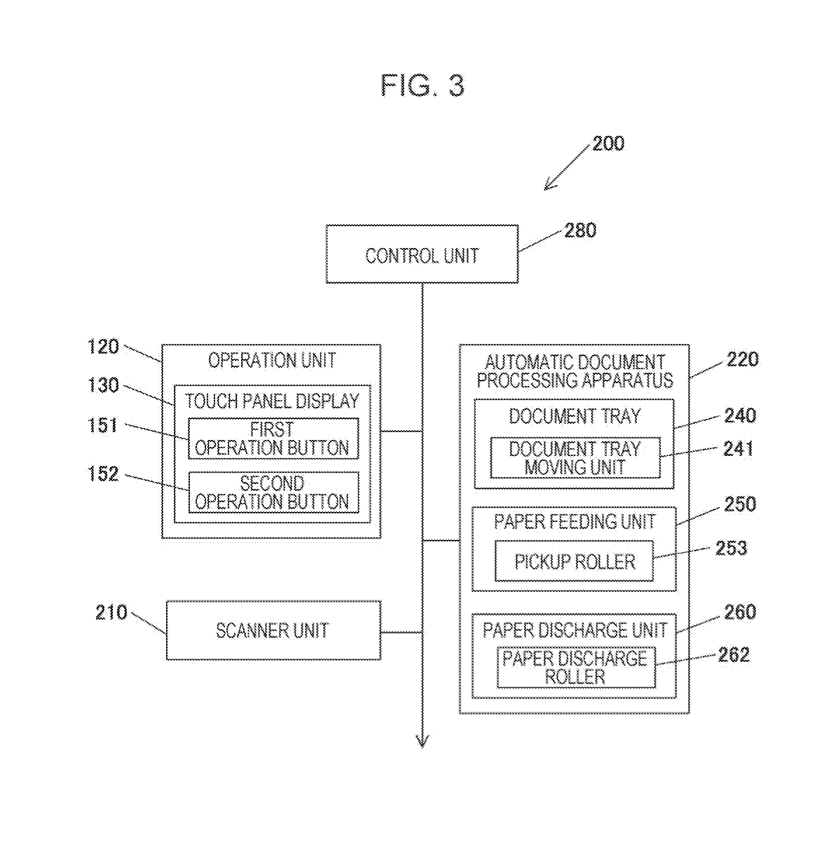

FIG. 3 is a block diagram illustrating an electrical configuration of the document reading apparatus according to the first embodiment.

As illustrated in FIG. 3, the document reading apparatus 200 causes the control unit 280 to control an operation process of the scanner unit 210 and an operation process and the automatic document processing apparatus 220.

The control unit 280 may constitute a part of a control unit (not illustrated) which controls an operation of the image forming apparatus 100. That is, the control unit of the image forming apparatus 100 may control an operation of the document reading apparatus 200.

A document tray moving unit 241 is provided in the document tray 240.

The document tray moving unit 241 moves the document tray 240 from a state in which the document is placed to a document feeding available state when a document is placed in the document tray 240.

The state in which the document is placed is a state in which the document can be moved or the document can be increasingly or decreasingly placed, and the document is not held in the state.

In the document feeding available state, the document placed on the document tray 240 is temporarily held by the pickup roller 253 of the paper feeding unit 250, and the document tray 240 is disposed at a position at which the document can be ted into the apparatus. In this state, the document may not be easily moved or reset.

On the touch panel display 130 of the operation unit 120, a first operation button 151 and a second operation button 152 capable of touch operation as soft keys are denoted.

The first operation button 151 is an operation button for instructing the document on the document tray 240 to be in the document feeding available state. When the first operation button 151 is touched, the document tray moving unit 241 is operated so that the document tray 240 is disposed at a position at which the document can be fed into the apparatus, and the pickup roller 253 is operated to press an end portion of the placed document so that the document is temporarily held by the pickup roller 253.

The second operation button 152 is an operation button for starting the document reading process. When the second operation button 152 is touched, the pickup roller 253 is operated to feed documents into the apparatus one by one, and the document reading process is automatically executed by the scanner unit 210 according to the document being transported.

After the document reading is completed, the document is discharged onto the paper discharge tray 265 by the paper discharge roller 262 of the paper discharge unit 260.

Next, the document reading process of the document reading apparatus 200 according to the first embodiment will be described with reference to a flowchart.

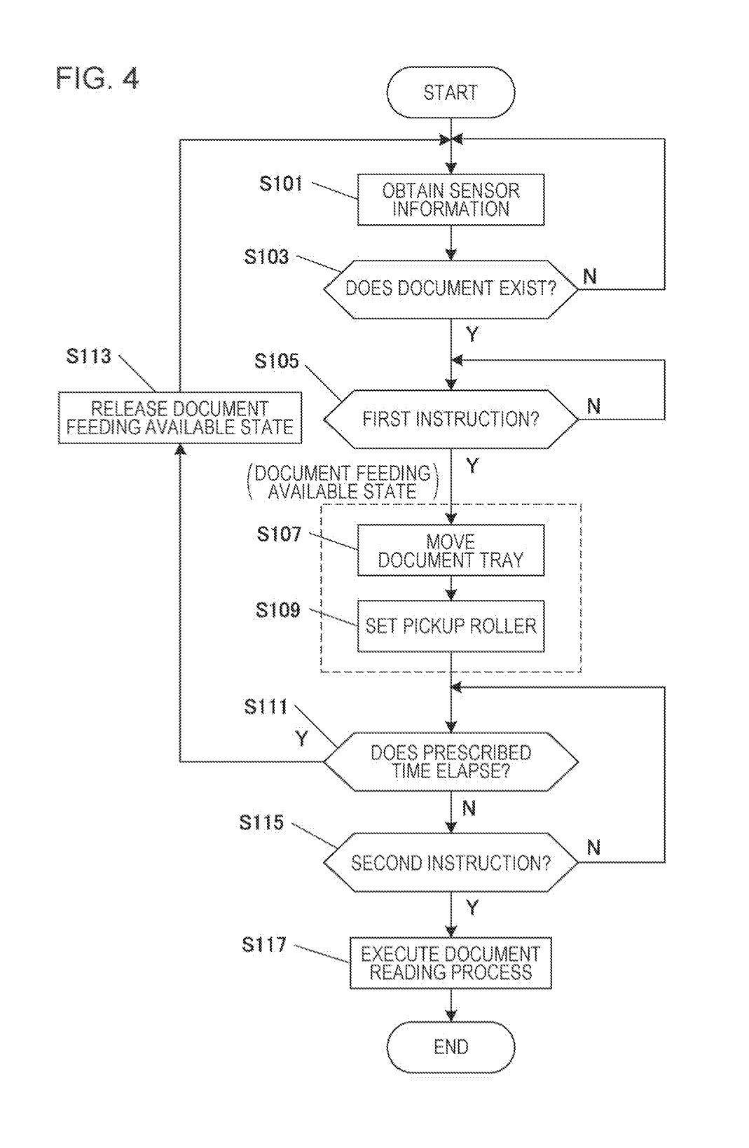

FIG. 4 is a flowchart illustrating an example of steps of a document reading process in the document reading apparatus according to the first embodiment.

As illustrated in FIG. 4, in the first embodiment, when the document reading apparatus 200 starts the document reading process, a document detection sensor or the like firstly detects a document on the document tray 240 (step S101) and it is determined whether or not the document is placed (step S103).

In step S103, in a case where it is determined that the document is placed, it is determined whether or not a first instruction of shifting the document into a paper feeding available state is performed (step S105).

In a case where it is determined that the first instruction is performed, for the document feeding available state, the document tray 240 is moved to a position at which the document can be fed (step S107) and the pickup roller 253 is disposed to temporally hold the document and to press the document from above (step S109).

It is determined whether or not a certain time (a prescribed time configured in advance) elapses while the document on the document tray 240 is in the document feeding available state (step S111).

in step S111, in a case where it is determined that the prescribed time elapses while the document is in the document feeding available state, the document feeding available state is released (step S113) and the process is returned to step S101.

In step S113, after the document feeding available state is released, the document reading process may be stopped.

On the other hand, in step S111, when it is determined that the prescribed time does not elapse while the document is in the document feeding available state, it is determined whether or not a second instruction of executing the document reading process is performed (step S115).

In step S115, in a case where it is determined that the second instruction is not performed, the process is returned to step S111.

On the other hand, in step S115, in a case where it is determined that the second instruction is performed, the document reading process is executed (step S117).

As described above, the document reading apparatus 200 performs the document reading process.

In this configuration described above, according to the first embodiment, in a case of reading a document placed on the document tray 240, the document reading apparatus 200 shifts the state in which the document is placed on the document tray 240 to the document feeding available state based on the first instruction and starts the reading process of the document from the document feeding available state based on the second instruction, so that the document is kept placed on the document tray 240 as long as the first instruction of being shifted to the document feeding available state is not executed. Thus, it is possible to easily set the document again or take the document out for reconfirmation.

In addition, in the first embodiment, since the document feeding available state is released when a prescribed time elapses while the document on the document tray 240 is in the document feeding available state, it is possible to easily perform the operation of removing the document when temporarily stopping the operation of reading the document.

Further, regarding the operation of releasing the document feeding available state of the document on the document tray 240, in addition to the process by the timeout, for example, in a case where an operation button (a job list, an administrator configuration button, or the like) other than an operation button associated an automatic document feeding of the first operation button 151, the second operation button 152, or the like after being shifted to the document feeding available state is pressed, the document feeding available state may be released.

### Second Embodiment

Next, the second embodiment will be described.

The document reading apparatus 200 according to the second embodiment has a feature in that when the document reading process is performed, after all of documents are fed (pass through the pickup roller 253) or after all of the documents are discharged (pass through the paper discharge roller 262), the document feeding available state is released.

Hereinafter, the document reading process of the document reading apparatus 200 will be described with reference to a flowchart.

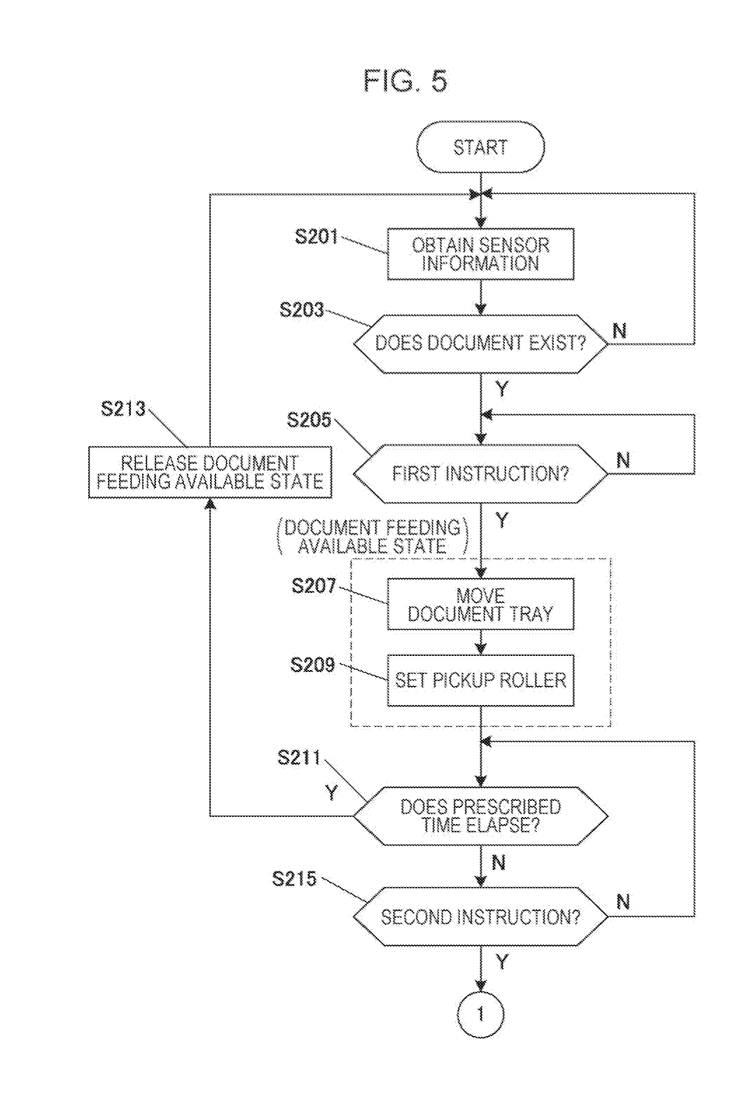

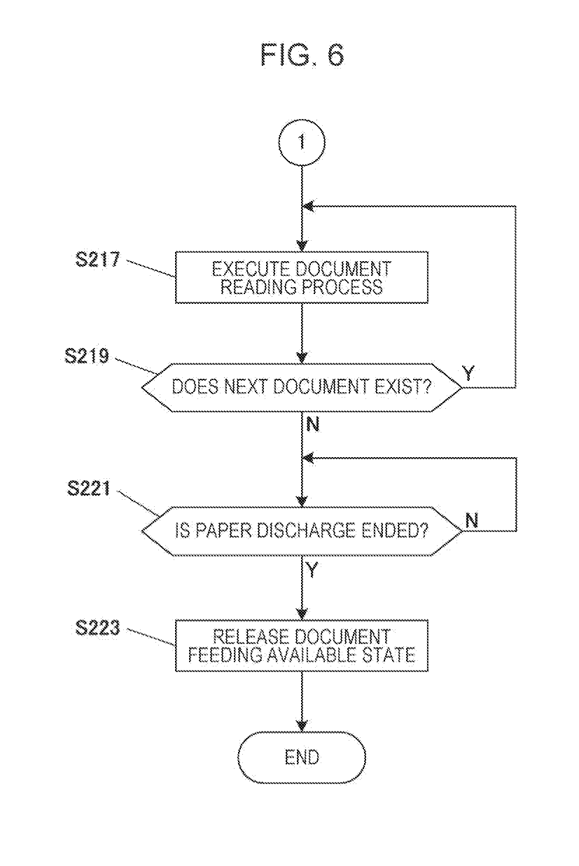

FIG. 5 is a part of a flowchart illustrating an example of steps of a document reading process in the document reading apparatus according to the second embodiment and FIG. 6 is a flowchart of the document reading process following the flowchart in FIG. 5.

A configuration of the document reading apparatus according to the second embodiment has the same configuration as the configuration of the document reading apparatus according to the first embodiment, so that description of the configuration will not be repeated.

As illustrated in FIG. 5, in the second embodiment, when the document reading apparatus 200 starts the document reading process, a document detection sensor or the like firstly detects a document on the document tray 240 (step S201) and it is determined whether or not the document is placed (step S203).

In step S203, in a case where it is determined that the document is placed, it is determined whether or not the first instruction of shifting the document into the paper feeding available state is performed (step S205).

In a case where it is determined that the first instruction is performed, for the document feeding available state, the document tray 240 is moved to a position at which the document can be fed (step S207) and the pickup roller 253 is disposed to temporally hold the document and to press the document from above (step S209).

It is determined whether or not a certain time (a prescribed time configured in advance) elapses while the document on the document tray 240 is in the document feeding available state (step S211).

In step S211, in a case where it is determined that the prescribed time elapses while the document is in the document feeding available state, the document feeding available state is released (step S213) and the process is returned to step S201.

In step S213, after the document feeding available state is released, the document reading process may be stopped.

On the other hand, in step S211, when it is determined that the prescribed time does not elapse while the document is in the document feeding available state, it is determined whether or not the second instruction of executing the document reading process is performed (step S215).

In step S215, in a case where it is determined that the second instruction is not performed, the process is returned to step S211.

On the other hand, in step S215, as illustrated in FIG. 6, in a case where it is determined that the second instruction is performed, the document reading process is executed (step S217). It is determined whether or not the next document exists (step S219).

In step S219, in a case where it is determined that the next document exists, the process is returned to step S217 and the document reading process iterates.

On the other hand, in step S219, in a case where it is determined that the next document does not exist, it is determined whether or not discharges of all of the documents are completed (step S221).

In step S221, in a case where it is determined that the discharges of all of the documents are completed, the document feeding available state is released (step S223) and the document reading process is completed.

As described above, the document reading apparatus 200 performs the document reading process.

In this configuration described above, according to the second embodiment, in a case of reading a document placed on the document tray 240, the document reading apparatus 200 releases the document feeding available state after all of the documents are fed or after all of the documents are discharged, so that the document can be stably fed without the document being dislocated during the document reading process. In addition, it is possible to suppress an operation of increasing or decreasing the document after starting the document reading process.

### Third Embodiment

Next, the third embodiment will be described.

The document reading apparatus according to the third embodiment has a feature in that when the document reading process is executed, all of the document are fed, and the document reading process is completed, the document feeding available state of the document tray and the paper feeding unit is released before all of the documents are discharged.

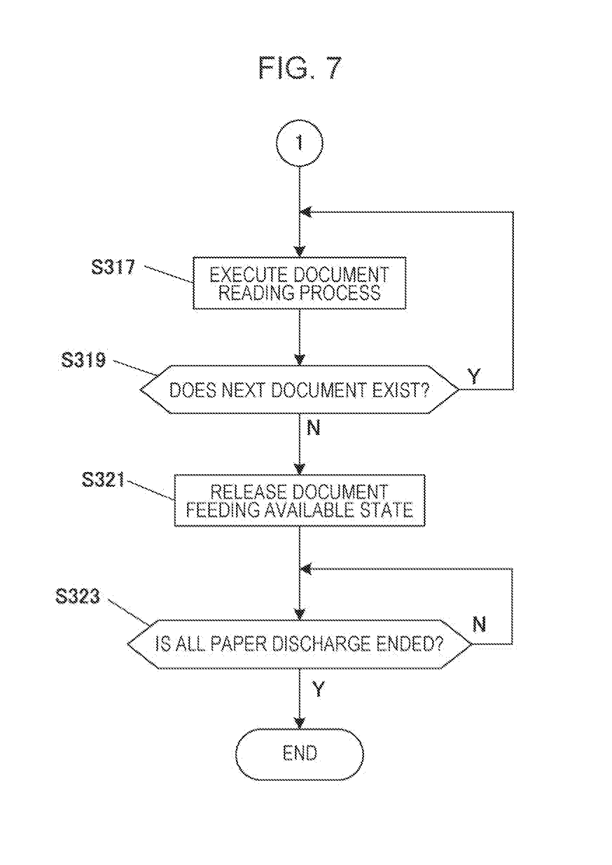

FIG. 7 is a part of a flowchart illustrating an example of steps of a document reading process in the document reading apparatus according to the third embodiment.

A configuration of the document reading apparatus according to the third embodiment has the same configuration as the configuration of the document reading apparatus according to the second embodiment, so that description of the configuration will not be repeated.

In addition, since among the steps of the document reading process by the document reading apparatus 200 according to the third embodiment, steps until the second instruction of executing the document reading process is performed are the same as the second embodiment, the steps refer to the flowchart in FIG. 5 of the second embodiment. Thus, in the third embodiment, the steps after the second instruction of executing the document reading process is performed will be described.

In the document reading apparatus 200 according to the third embodiment, the process until the document feeding available state is performed according to the flowchart illustrated in FIG. 5. In a case where it is determined that the second instruction is performed, as illustrated in FIG. 7, the document reading process is executed (step S317) and it is determined whether or not the next document exists (step S319).

In step S319, in a case where it is determined that the next document exists, the process is returned to step S317 and the document reading process iterates.

On the other hand, in step S319, in a case where it is determined that the next document does not exist, the document feeding available state is released (step S321). It is determined whether or not discharges of all of the documents are completed (step S323).

In step S321, in a case where it is determined that the discharges of all of the documents are completed, the document reading process is completed.

As described above, the document reading apparatus 200 performs the document reading process.

In this configuration described above, according to the third embodiment, in a case of reading a document placed on the document tray 240, the document reading apparatus 200 releases the document feeding available state before all of the documents are fed and all of the documents are discharged, so that in a case where it is desired to add a document to be read, it is possible to easily set the document on the document tray 240.

### Fourth Embodiment

Next, the fourth embodiment will be described.

The document reading apparatus according to the fourth embodiment has a feature in that in a case where the document reading process is executed, reading the document is completed, and all of the discharged documents are removed, the document feeding available state of the document tray and the paper feeding unit is released.

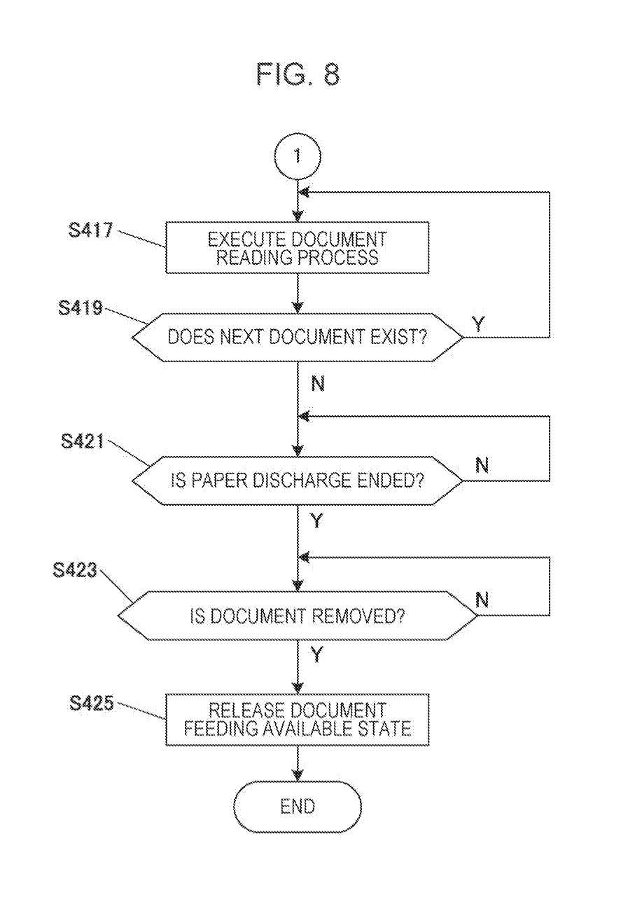

FIG. 8 is a part of a flowchart illustrating an example of steps of a document reading process in the document reading apparatus according to the fourth embodiment.

A configuration of the document reading apparatus according to the fourth embodiment has the same configuration as the configuration of the document reading apparatus according to the second embodiment, so that description of the configuration will not be repeated.

In addition, since among the steps of the document reading process by the document reading apparatus 200 according to the fourth embodiment, steps until the second instruction of executing the document reading process is performed are the same as the second embodiment, the steps refer to the flowchart in FIG. 5 of the second embodiment. Thus, in the fourth embodiment, the steps after the second instruction of executing the document reading process is performed will be described.

In the document reading apparatus 200 according to the fourth embodiment, the process until the document feeding available state is performed according to the flowchart Illustrated in FIG. 5. In a case where it is determined that the second instruction is performed, as illustrated in FIG. 8, the document reading process is executed (step S417) and it is determined whether or not the next document exists (step S419).

In step S419, in a case where it is determined that the next document exists, the process is returned to step S417 and the document reading process iterates.

On the other hand, in step S419, in a case where it is determined that the next document does not exist, it is determined whether or not a discharge of the document is completed (step S421).

In step S421, in a case where it is determined that the discharge of the document is completed, it is determined whether or not the discharged document is removed (step S423).

In step S423, in a case where it is determined that the discharged document is removed, the document feeding available state is released (step S425) and the document reading process is completed.

As described above, the document reading apparatus 200 performs the document reading process.

In this configuration described above, according to the fourth embodiment, in a case of reading a document placed on the document tray 240, the document reading apparatus 200 releases the document feeding available state in the document tray and the paper feeding unit in a case where all of the discharged documents are removed, so that in a case where it is desired to set a next document to be read on the document tray 240, it is possible to easily set the document.

### Fifth Embodiment

Next, the fifth embodiment will be described.

The document reading apparatus according to the fifth embodiment has a feature in that in a case where a next document is placed on the document tray 240 in a state in which the document reading process is executed, reading the document is completed, and all of the discharged documents are not removed, the document feeding available state is released.

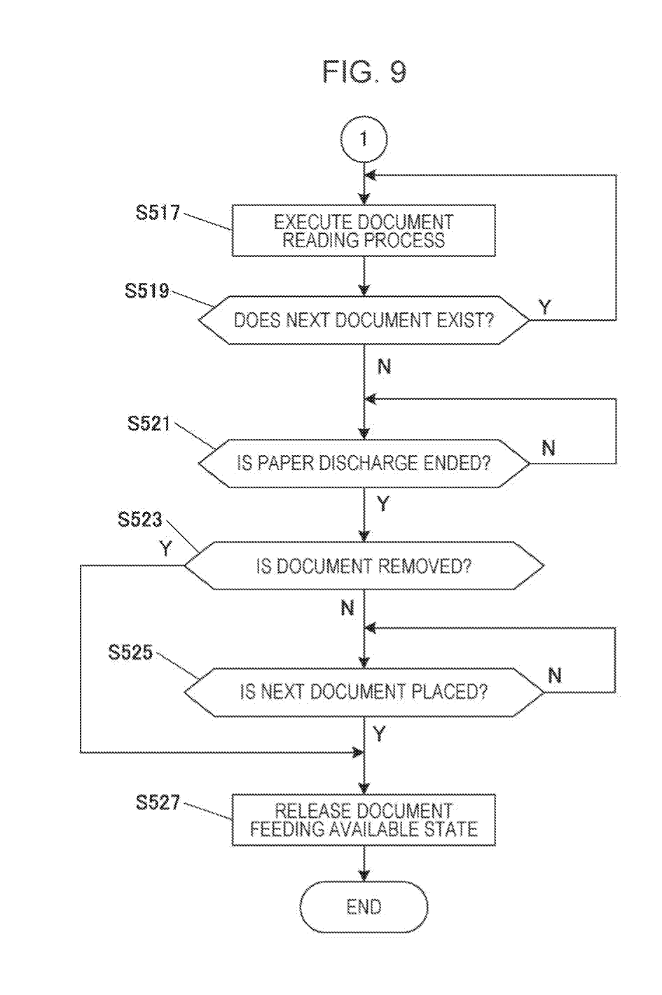

FIG. 9 is a part of a flowchart illustrating an example of steps of a document reading process in the document reading apparatus according to the fifth embodiment.

A configuration of the document reading apparatus according to the fifth embodiment has the same configuration as the configuration of the document reading apparatus according to the second embodiment, so that description of the configuration not be repeated.

In addition, since among the steps of the document reading process by the document reading apparatus 200 according to the fifth embodiment, steps until the second instruction of executing the document reading process is performed are the same as the second embodiment, the steps refer to the flowchart in FIG. 5 of the second embodiment. Thus, in the fifth embodiment, the steps after the second instruction of executing the document reading process is performed will be described.

In the document reading apparatus 200 according to the fifth embodiment, the process until the document feeding available state is performed according to the flowchart illustrated in FIG. 5. In a case where it is determined that the second instruction is performed, as illustrated in FIG. 9, the document reading process is executed (step S517) and it is determined whether or not the next document exists (step S519).

In step S519, in a case where it is determined that the next document exists, the process is returned to step S517 and the document reading process iterates.

On the other hand, in step S519, in a case where it is determined that the next document does not exist, it is determined whether or not a discharge of the document is completed (step S521).

In step S521, in a case where it is determined that the discharge of the document is completed, it is determined whether or not the discharged document is removed (step S523).

In step S523, in a case where it is determined that the discharged document is removed, the document feeding available state is released (step S527) and the document reading process is completed.

On the other hand, in step S523, in a case where the discharged document is not removed, it is determined whether or not the next document to be read is disposed on the document tray 240 (step S525).

In step S525, in a case where it is determined that the next document to be read is disposed on the document tray 240, the document feeding available state is released (step S527) and the document reading process is completed.

As described above, the document reading apparatus 200 performs the document reading process.

In this configuration described above, in the document reading apparatus 200 according to the fifth embodiment, in a case where the document reading process is executed and a next document is placed on the document tray 240 in a state in which all of the discharged documents are not removed when reading the document is completed, it is possible to easily set the next document to be read on the document tray 240 by releasing the document feeding available state.

### Sixth Embodiment

Next, the sixth embodiment will be described.

The document reading apparatus according to the sixth embodiment has a feature in that in a case where the document reading process is executed and a next document is placed on the document tray 240 in a state in which all of the discharged documents are not removed, the document feeding available state is released and a message for notifying whether or not image data of a first document placed on the document tray 240 first and image data of a second document placed next on the document tray 240 after discharging the first document are combined is further denoted on a display unit of the document reading apparatus.

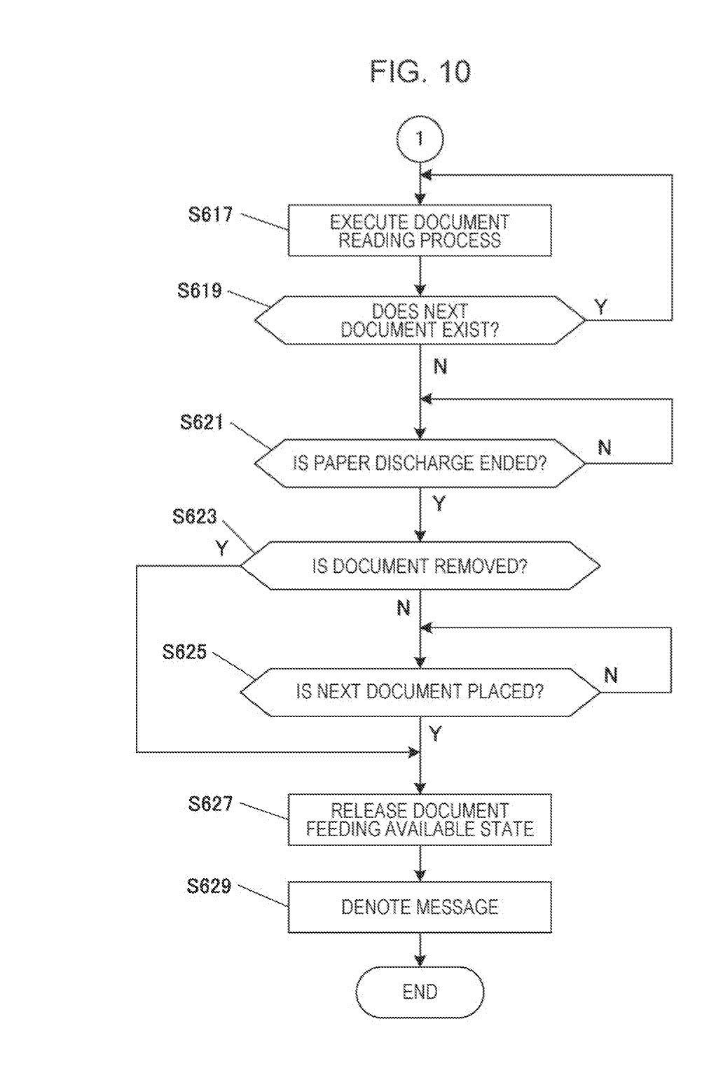

FIG. 10 is a part of a flowchart illustrating an example of steps of a document reading process in the document reading apparatus according to the sixth embodiment.

A configuration of the document reading apparatus according to the sixth embodiment has the same configuration as the configuration of the document reading apparatus according to the second embodiment, so that description of the configuration will not be repeated.

In addition, since among the steps of the document reading process by the document reading apparatus 200 according to the sixth embodiment, steps until the second instruction of executing the document reading process is performed are the same as the second embodiment, the steps refer to the flowchart in FIG. 5 of the second embodiment. Thus, in the sixth embodiment, the steps after the second instruction of executing the document reading process is performed will be described.

In the document reading apparatus 200 according to the sixth embodiment, the process until the document feeding available state is performed according to the flowchart illustrated in FIG. 5. In a case where it is determined that the second instruction is performed, as illustrated in FIG. 10, the document reading process is executed (step S617) and it is determined whether or not the next document exists (step S619).

In step S619, in a case where it is determined that the next document exists, the process is returned to step S617 and the document reading process iterates.

On the other hand, in step S619, in a case where it is determined that the next document does not exist, it is determined whether or not a discharge of the document is completed (step S621).

In step S621, in a case where it is determined that the discharge of the document is completed, it is determined whether or not the discharged document is removed (step S623).

In step S623, in a case where it is determined that the discharged document is removed, the document feeding available state is released (step S627).

On the other hand, in step S623, in a case where the discharged document is not removed, it is determined whether or not the next document to be read is disposed on the document tray 240 (step S625).

In step S625, in a case where it is determined that the next document to be read is disposed on the document tray 240, the document feeding available state is released (step S627).

In step S627, when the document feeding available state is released, a message for notifying whether or not image data of the first document placed on the document tray 240 first and image data of the second document placed on the document tray 240 next after discharging the first document are combined is denoted on a display screen of the touch panel display 130 in step S629.

As described above, the document reading apparatus 200 performs the document reading process.

In this configuration described above, in the document reading apparatus 200 according to the sixth embodiment, in a case where the document reading process is executed and a next document is placed on the document tray 240 in a state in which all of the discharged documents are not removed when reading the document is completed, it is possible to easily set the next document to be read on the document tray 240 by releasing the document feeding available state and denoting the message for notifying whether or not the image data of the first document placed on the document tray 240 first and the image data of the second document placed on the document tray 240 next after discharging the first document are combined on the display screen of the touch panel display 130, and it is possible to combine and store the image data of the first document placed first and the image data of the second document placed next in one file in a storage unit (not illustrated) or to store each of pieces of the image data of the document in each of files.

### Seventh Embodiment

Next, the seventh embodiment will be described.

The seventh embodiment includes a light emitting unit (a light emitting portion) in addition to the configuration of the document reading apparatus 200 according to the second embodiment and has a feature in that light emitting modes in the state in which the document is placed, the document feeding available state, and the state after the document is discharged are different from one another.

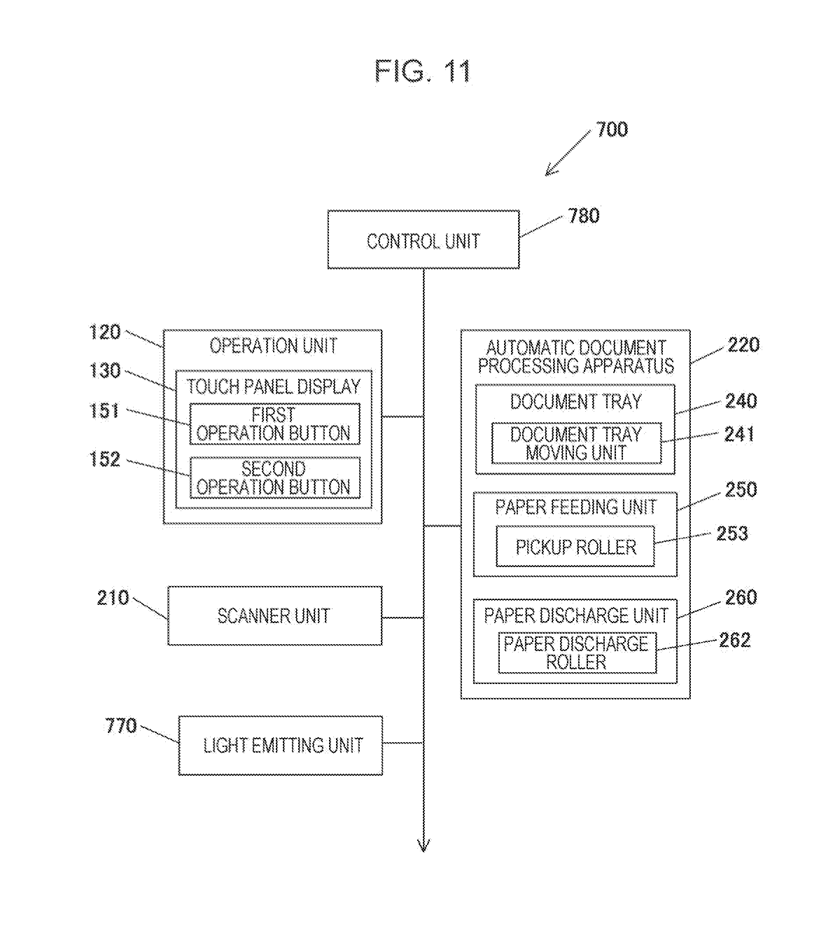

FIG. 11 is a block diagram illustrating an electrical configuration of the document reading apparatus according to the seventh embodiment.

A configuration of the document reading apparatus according to the seventh embodiment has the same configuration as the configuration of the document reading apparatus according to the second embodiment, so that description of the configuration will not be repeated by denoting the same reference numerals to the same components.

As illustrated in FIG. 11, a document reading apparatus 700 according to the seventh embodiment includes a light emitting unit 770 in addition to the configuration of the document reading apparatus 200 according to the second embodiment. The document reading apparatus 700 causes a control unit 780 to control light emitting modes (modes by color, blinking, or the like) in the state in which the document is placed, the document feeding available state, and the state after the document is discharged to be different from one another.

The light emitting unit 770 broadcasts a state of the document during a document reading process to the user by blinking an LED. The light emitting unit 770 is controlled to change the light emitting modes according to the state in which the document is placed, the document feeding available state, and the state after the document is discharged by changing a color of the LED or changing a blinking state.

Next, the document reading process of the document reading apparatus 700 will be described with reference to a flowchart.

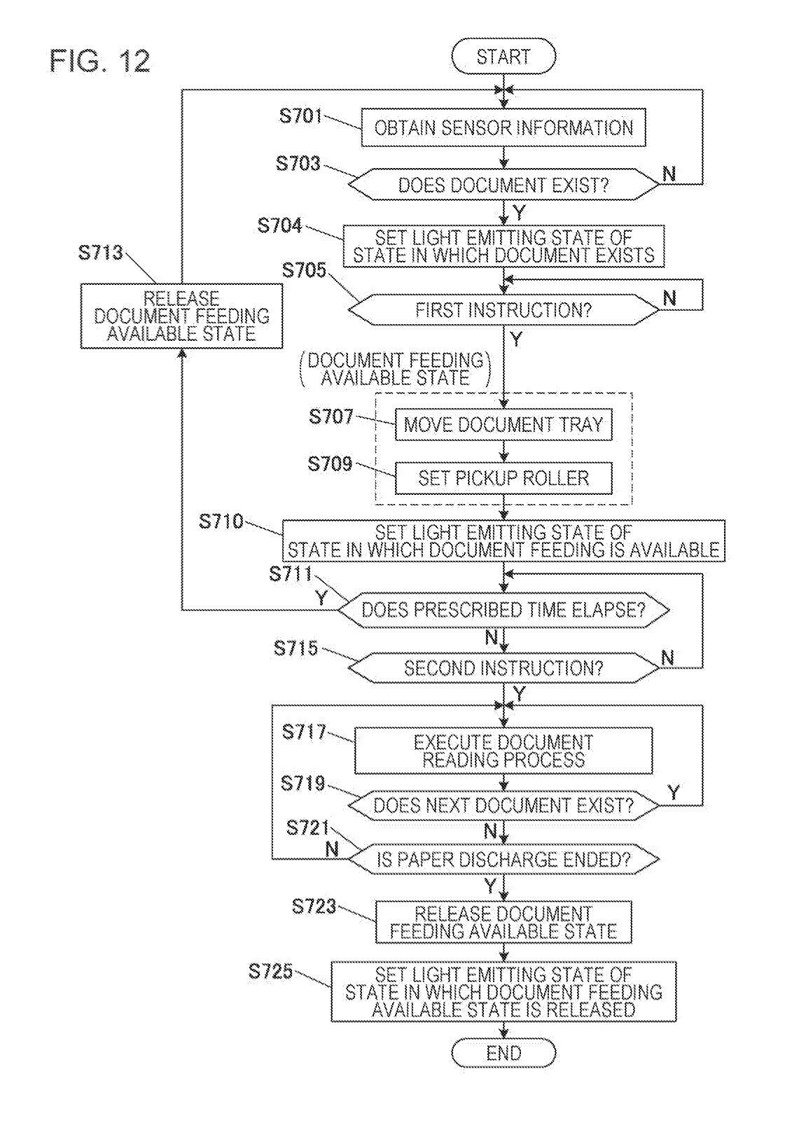

FIG. 12 is a flowchart illustrating an example of steps of the document reading process in the document reading apparatus according to the seventh embodiment.

As illustrated in FIG. 12, in the seventh embodiment, when the document reading apparatus 700 starts the document reading process, a document detection sensor or the like firstly detect a document on the document tray 240 (step S701) and it is determined whether or not the document is placed (step S703).

In step S703, in a case where it is determined that the document is placed, it is broadcasted that the document is placed on the document tray 240 by blinking the LED of the light emitting unit 770 in a short cycle (step S704).

It is determined whether or not the first instruction of shifting the document into the paper feeding available state is performed (step S705).

In a case where it is determined that the first instruction is performed, for the document feeding available state, the document tray 240 is moved to a position at which the document can be fed (step S707) and the pickup roller 253 is disposed to temporally hold the document and to press the document from above (step S709).

It is broadcasted that the document is in the document feeding available state by blinking the LED of the light emitting unit 770 in a cycle longer than before (step S710).

It is determined whether or not a certain time (a prescribed time configured in advance) elapses while the document on the document tray 240 is in the document feeding available state (step S711).

In step S711, in a case where it is determined that the prescribed time elapses while the document is in the document feeding available state, the document feeding available state is released (step S713) and the process is returned to step S701.

In step S713, after the document feeding available state is released, the document reading process may be stopped.

On the other hand, in step S711, when it is determined that the prescribed time does not elapse while the document is in the document feeding available state, it is determined whether or not the second instruction of executing the document reading process is performed (step S715).

In step S715, in a case where it is determined that the second instruction is not performed, the process is returned to step S711.

On the other hand, in step S715, in a case where it is determined that the second instruction is performed, the document reading process is executed (step S717). It is determined whether or not the next document exists (Step S719).

In step S719, in a case where it is determined that the next document exists, the process is returned to step S717.

On the other hand, in step S719, in a case where it is determined that the next document does not exist, it is determined whether or not discharges of all of the documents are completed (step S721).

In step S721, in a case where it is determined that the discharges of all of the documents are completed, the document feeding available state is released (step S723).

It is broadcasted that the document feeding available state is released by blinking the LED of the light emitting unit 770 in a cycle further longer than before (step S725). Thus, the document reading process is completed.

As described above, the document reading apparatus 700 performs the document reading process.

In a case where it is determined that the discharges of all of the documents are completed, the document feeding available state is released (step S723) and the document reading process is completed.

As described above, the document reading apparatus 700 performs the document reading process.

In this configuration described above, according to the seventh embodiment, the document reading apparatus 700 further includes the light emitting unit 770. By varying the light emitting modes of the LED in the state in which the document is placed, the document feeding available state, and the state after the document is discharged, it is possible to visually broadcast the state of the document to the user.

In the seventh embodiment, the light emitting mode is changed so that the blinking circle of the LED by the light emitting unit 770 is changed according to the state of the document, but the color of the LED may be changed according to the state of the document, for example.

### Eighth Embodiment

Next, the eighth embodiment will be described.

The eighth embodiment includes a person detecting sensor in addition to the configuration of the document reading apparatus 200 according to the first embodiment, and has a feature in that in a case where a user who is using the document reading apparatus is separated from the document reading apparatus by a prescribed distance or more, the document on the document tray 240 is discharged.

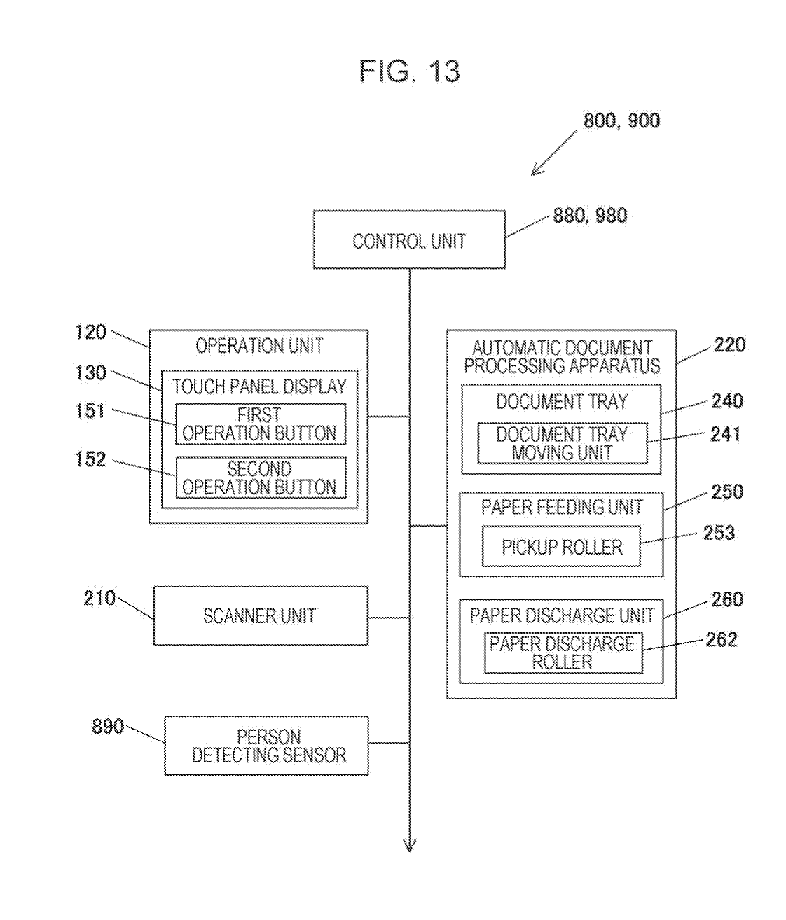

FIG. 13 is a block diagram illustrating an electrical configuration of the document reading apparatus according to the eighth embodiment.

A configuration of the document reading apparatus according to the eighth embodiment has the same configuration as the configuration of the document reading apparatus according to the first embodiment, so that description of the configuration will not be repeated by denoting the same reference numerals to the same components.

As illustrated in FIG. 13, a document reading apparatus 800 according to the eighth embodiment includes a person detecting sensor 890 in addition to the configuration of the document reading apparatus 200 according to the first embodiment. In a case where the user who is using the document reading apparatus 800 is separated from the document reading apparatus 800 by a prescribed distance or more in the state in which the document is placed on the document tray 240, the document reading apparatus 800 causes a control unit 880 to control the document on the document tray 240 being discharged.

The person detecting sensor 890 is set so as to detect that the user is separated from the document reading apparatus 800 in a case where the user who is using the document reading apparatus 800 (or an image forming apparatus) is separated from the document reading apparatus 800 by a configured distance (a threshold value) or more.

Next, a document reading process of the document reading apparatus 800 will be described with reference to a flowchart.

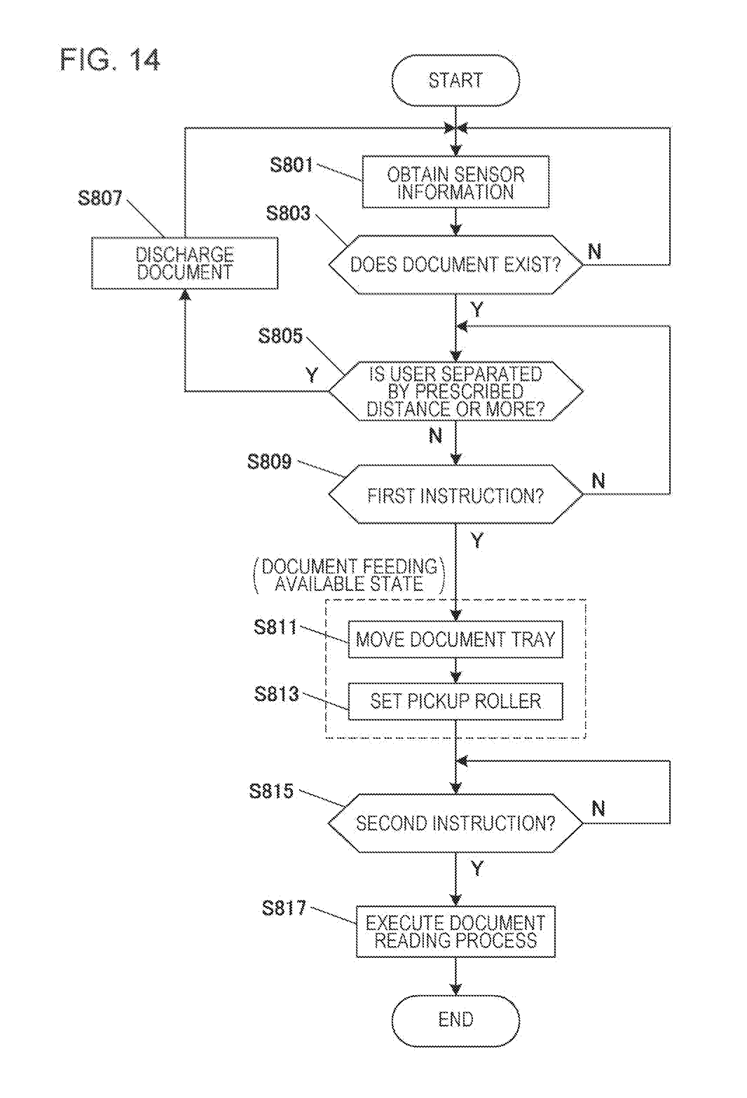

FIG. 14 is a flowchart illustrating an example of steps of the document reading process in the document reading apparatus according to the eighth embodiment.

As illustrated in FIG. 14, in the eighth embodiment, when the document reading apparatus 800 starts the document reading process, a document detection sensor or the like firstly detects a document on the document tray 240 (step S801) and it is determined whether or not the document is placed (step S803).

In step S803, in a case where it is determined that the document is placed, it is determined whether or not the user is separated from the document reading apparatus 800 by a prescribed distance or more (step S805).

In step S805, in a case where it is determined that the user is separated from the document reading apparatus 800 by the prescribed distance or more, the document is discharged from the document tray 240 to the paper discharge tray 265 (step S807) and the process is returned to step S801.

On the other hand, in step S805, in a case where it is determined that the user is not separated from the document reading apparatus 800 by the prescribed distance or more, it is determined whether or not the first instruction of shifting the document into the paper feeding available state is performed (step S809).

In a case where it is determined that the first instruction is performed, for the document feeding available state, the document tray 240 is moved to a position at which the document can be fed (step S811) and the pickup roller 253 is disposed to temporally hold the document and to press the document from above (step S813).

It is determined whether or not the second instruction of executing the document reading process is performed (step S815).

In step S815, in a case where it is determined that the second instruction is performed, the document reading process is executed (step S817).

As described above, the document reading apparatus 800 performs the document reading process.

In this configuration described above, the document reading apparatus 800 according to the eighth embodiment further includes the person detecting sensor 890. In a case where the user who is using the document reading apparatus 800 is separated from the document reading apparatus 800 by the prescribed distance or more in the state in which the document is placed on the document tray 240, the document on the document tray 240 is discharged, so that it is possible to suppress the document, of which a user is absent, being left on the document tray 240 and to suppress a loss of the documents and a leakage of information.

In addition, in the eighth embodiment, the person. detecting sensor 890 detects that the user is separated when the document is placed on the document tray 240 and the document is discharged, but the person detecting sensor 890 may detect that the user is separated and the document may be discharged when the document is in the document feeding available state, for example. With this configuration, it is possible to suppress the document, of which a user is absent, being left on the document tray 240 even in the document feeding available state and to suppress a loss of the documents and a leakage of information.

### Ninth Embodiment

Next, the ninth embodiment will be described.

In addition to the state in which the user who is using the document reading apparatus is separated from the document reading apparatus by the prescribed distance or more in the document reading apparatus 800 according to the eighth embodiment, the ninth embodiment has a feature in that in a case where a prescribed time further elapses after the user is separated from the document reading apparatus, the document on the document tray 240 is discharged.

A configuration of the document reading apparatus according to the ninth embodiment has the same configuration as the configuration of the document reading apparatus according to the eighth embodiment, so that description of the configuration will not be repeated.

As illustrated in FIG. 13, a document reading apparatus 900 according to the ninth embodiment includes the person detecting sensor 890. In a case where the user who is using the document reading apparatus 900 is separated from the document reading apparatus 900 by the prescribed distance or more in the state in which the document is placed on the document tray 240 and a prescribed time further elapses after the user is separated from the document reading apparatus 900, the document reading apparatus 900 causes a control unit 980 to control the document on the document tray 240 being discharged.

Next, a document reading process of the document reading apparatus 900 will be described with reference to a flowchart.

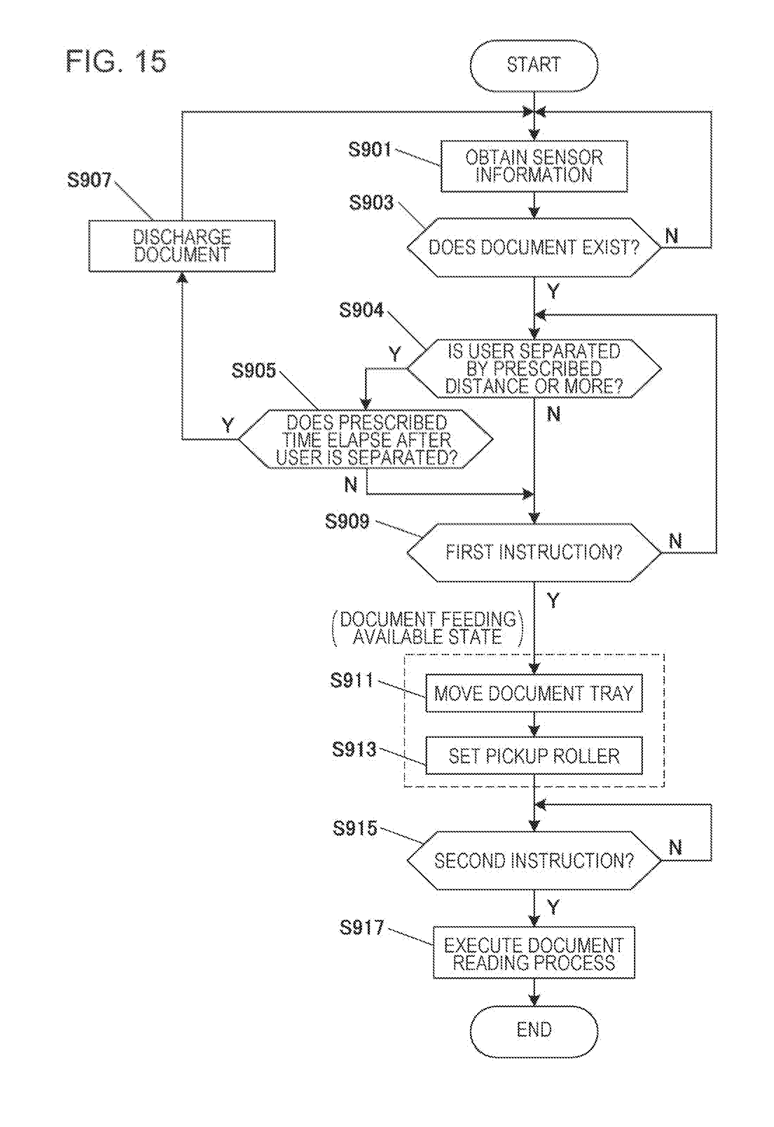

FIG. 15 is a flowchart illustrating an example of steps of the document reading process in the document reading apparatus according to the ninth embodiment.

As illustrated in FIG. 15, in the ninth embodiment, when the document reading apparatus 900 starts the document reading process, a document detection sensor or the like firstly detects a document on the document tray 240 (step S901) and it is determined whether or not the document is placed (step S903).

In step S903, in a case where it is determined that the document is placed, it is determined whether or not the user is separated from the document reading apparatus 900 by a prescribed distance or more (step S904).

In step S904, in a case where it is determined that the user is separated from the document reading apparatus 900 by the prescribed distance or more, it is further determined whether or not a prescribed time elapses after the user is separated from the document reading apparatus 900 (step S905).

In step S905, in a case where it is determined that the prescribed time elapses after the user is separated, the document is discharged from the document tray 240 to the paper discharge tray 265 (step S907) and the process is returned to step S901.

On the other hand, in step S904, in a case where it is determined that the user is not separated from the document reading apparatus 900 by the prescribed distance or more, it is determined whether or not the first instruction of shifting the document into the paper feeding available state is performed (step S909).

In addition, in step S905, in a case where it is determined that the prescribed time does not elapse after the user is separated, the process proceeds to step S909.

In step S909, in a case where it is determined that the first instruction is not performed, the process is returned to step S904.

On the other hand, in step S909, in a case where it is determined that the first instruction is performed, for the document feeding available state, the document tray 240 is moved to the position at which the document can be fed (step S911) and the pickup roller 253 is disposed to temporally hold the document and to press the document from above (step S913).

It is determined whether or not the second instruction of executing the document reading process is performed (step S915).

In step S915, in a case where it is determined that the second instruction is performed, the document reading process is executed (step S917).

As described above, the document reading apparatus 900 performs the document reading process.

In this configuration described above, the document reading apparatus 900 according to the ninth embodiment further includes the person detecting sensor 890. In a case where the user who is using the document reading apparatus 900 is separated from the document reading apparatus 900 by the prescribed distance or more and the prescribed time further elapses after the user is separated from the document reading apparatus in the state in which the document is placed on the document tray 240, the document on the document tray 240 is discharged, so that it is possible to set a condition that the document is discharged, and it is further possible to suppress the document, of which a user is absent, being left on the document tray 240 and to suppress a loss of the documents and a leakage of information.

In addition, in the ninth embodiment, the person detecting sensor 890 detects that the user is separated when the document is placed on the document tray 240 and the document is discharged in a case where the prescribed time elapses after the user is separated from the document reading apparatus, but the person detecting sensor 890 may detect that the user is separated when the document is in the document feeding available state and the document may be discharged in a case where the prescribed time elapses after the user is separated from the document reading apparatus, for example. With this configuration, it is possible to suppress the document, of which a user is absent, being left on the document tray 240 even in the document feeding available state and to suppress a loss of the documents and a leakage of information.

In the embodiment described above, in a case of removing the document placed on the document tray 240, the document is removed in a state in which the document is placed on the document tray 240 or a state in which the document feeding available state is released, the document feeding available state may be released by removing the document in the document feeding available state, for example. With this configuration, in a case where it is desired to immediately remove a document in emergency, after removing the document, the document can be placed again.

The present invention is not limited to the embodiments described above, and various modifications may be made without departing from the spirit of the present claims. It should be understood by those skilled in the art that various modifications, combinations, sub-combinations and alterations may occur depending on design requirements and other factors insofar as they are within the scope of the appended claims or the equivalents thereof.

The present disclosure contains subject matter related to that disclosed in Japanese Priority Patent Application JP 2018-079355 filed in the Japan Patent Office on Apr. 17, 2018, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A document reading apparatus which automatically transports a document placed on a document tray to read an image,
wherein in a case of reading the document placed on the document tray, shifting a state in which the document is placed to a document feeding available state is performed based on a first instruction, and
a reading process of the document is started based on a second instruction.

2. The document reading apparatus according to claim 1,
wherein a portion for shifting to the document feeding available state enable an operation including at least one of an operation of moving the document tray or an operation of pressing the document.

3. The document reading apparatus according to claim 1,
wherein the document feeding available state is released when a prescribed time elapses after the shifting to the document feeding available state.

4. The document reading apparatus according to claim 1,
wherein the document feeding available state is released after all of the documents are fed or all of the documents are discharged.

5. The document reading apparatus according to claim 1,
wherein the document feeding available state is released after all of the documents are fed and before all of the documents are discharged.

6. The document reading apparatus according to claim 1,
wherein the document feeding available state is released in a case where all of the documents are discharged and all of the discharged documents are removed.

7. The document reading apparatus according to claim 6,
wherein the document feeding available state is released in a case where a next document is placed on the document tray in a state in which the discharged document is not removed.

8. The document reading apparatus according to claim 7, comprising:
a display unit,
wherein a message for notifying whether or not image data of a first document placed on the document tray first and image data of a second document placed on the document tray next after discharging the first document are combined is denoted on the display unit.

9. The document reading apparatus according to claim 1,
wherein the shifting to the document feeding available state is performed in a case where an operation button associated with automatic document feeding is pressed.

10. The document reading apparatus according to claim 1,
wherein the document feeding available state is released in a case where an operation button other than an operation button associated with automatic document feeding is pressed after the shifting to the document feeding available state.

11. The document reading apparatus according to claim 1, comprising:
a light emitting portion,
wherein the light emitting portion has light emitting modes different between the state in which the document is placed, the document feeding available state, and a state after the document is discharged.

12. The document reading apparatus according to claim 1,
wherein the document on the document tray is discharged. in a case where a user who is using the document reading apparatus is separated from the document reading apparatus by a prescribed distance or more in the state in which the document is placed on the document tray.

13. The document reading apparatus according to claim 1,
wherein the document on the document tray is discharged in a case where a prescribed time elapses after a user who is using the document reading apparatus is separated from the document reading apparatus in the state in which the document is placed on the document tray.

14. The document reading apparatus according to claim 1,
wherein the document feeding available state is released when the document is removed in the document feeding available state.

15. A document reading method for automatically transporting a document placed on a document tray to read an image, the method comprising:
in a case of reading the document placed on the document tray, shifting a state in which the document is placed to a document feeding available state based on a first instruction; and
starting a reading process of the document based on a second instruction.

16. A storage medium storing control program for operating a document reading apparatus which automatically transports a document placed on a document tray to read an image, the program causing a computer to function to:
in a case of reading the document placed on the document tray, shift a state in which the document is placed to a document feeding available state based on a first instruction; and
start a reading process of the document based on a second instruction.
